(19) United States
(12) Patent Application Publication
(10) Pub. No.: US 2021/0255025 A1
(43) Pub. Date: Aug. 19, 2021

(54) METHOD OF DETECTING LIQUID LEVEL OF PRINTING MATERIAL OF THREE-DIMENSIONAL PRINTER

(71) Applicants: XYZPRINTING, INC., NEW TAIPEI CITY (TW); KINPO ELECTRONICS, INC., NEW TAIPEI CITY (TW)

(72) Inventor: Yao-Te HUANG, NEW TAIPEI CITY (TW)

(21) Appl. No.: 16/892,860

(22) Filed: Jun. 4, 2020

(30) Foreign Application Priority Data
Feb. 18, 2020 (CN) 202010098788.X

(51) Int. Cl. G01F 23/292; B33Y 50/00; B33Y 40/00; B29C 64/255; B29C 64/321; B29C 64/386; B29C 64/112

(52) U.S. Cl. CPC G01F 23/2921; B33Y 50/00; B33Y 40/00; B29C 64/112; B29C 64/321; B29C 64/386; B29C 64/255

(57) ABSTRACT

A method of detecting liquid level of printing material of a three-dimensional printer includes steps of: (a) providing a printing material tank and a sensor, (b) injecting a printing material into the printing material tank, (c) outputting, by the sensor, a first voltage signal and continuously injecting the printing material when the sensor does not detect the printing material, and (d) outputting, by the sensor, a second voltage signal and stopping injecting the printing material when the sensor detects the printing material, wherein a voltage level of the first voltage signal is greater than a voltage level of the second voltage signal.

### BACKGROUND

### Technical Field

The present disclosure relates to a method of detecting a liquid level of a printing material of a three-dimensional printer, and more particularly to a method of detecting a liquid level of a printing material of a three-dimensional printer applicable to transparent printing material and white printing material.

### Description of Related Art

The statements in this section merely provide background information related to the present disclosure and do not necessarily constitute prior art.

Additive manufacturing technology, also known as 3D printing, is an emerging technology that is rapidly developing in the manufacturing industry today. The main process of manufacturing articles with this technology is: using computer aided design (CAD) to build solid models, and then dividing the built 3D model into layered sections, and then entering the profile file into the molding equipment, and then printing these sections layer by layer using liquid, powder, and silk starting materials, and then removing objects from the device after molding, and finally acquiring the required final product after processing.

Material jetting technology is one of the types of laminated manufacturing technology. How to control the liquid surface of the printing material (or called printing ink, printing liquid) including the model material and the support material in the printing material tank (i.e., the tank where the printing material is installed) is important. If there is too little printing material in the tank, it will cause the empty tank to be free of printing ink during the printing process, resulting in printing molding failure. Conversely, if there is too much printing material in the tank, the ink is refilled into the air pressure system and the system would be damaged.

### SUMMARY

An object of the present disclosure is to provide a method of detecting a liquid level of a printing material of a three-dimensional printer to solve a problem caused by too much or too little printing ink in the printing material tank.

In order to achieve the above-mentioned object, the method of detecting the liquid level of the printing material of the three-dimensional printer includes steps of: (a) providing a printing material tank and a sensor, (b) injecting a printing material into the printing material tank, (c) outputting, by the sensor, a first voltage signal and continuously injecting the printing material when the sensor does not detect the printing material, and (d) outputting, by the sensor, a second voltage signal and stopping injecting the printing material when the sensor detects the printing material, wherein a voltage level of the first voltage signal is greater than a voltage level of the second voltage signal.

In one embodiment, before the step (a) further includes steps of: (a1) detecting whether an output voltage of the sensor is greater than or equal to a first detection voltage under a condition without the printing material, (a2) using the sensor for detecting the liquid level of the printing material when the output voltage is greater than or equal to the first detection voltage, and (a3) not being used for liquid level detection of the printing material when the output voltage is less than the first detection voltage.

In one embodiment, further includes steps of: (e01) adjusting an output voltage of the sensor to be greater than or equal to a second detection voltage under the condition without the printing material, (e02) adjusting the output voltage is less than or equal to a third detection voltage under a condition of filling the printing material, wherein the second detection voltage is greater than the third detection voltage, (e03) using the sensor for detecting the liquid level of the printing material when the step (e01) and the step (e02) are both satisfied, and (e04) not being used for liquid level detection of the printing material when at least one of the step (e01) and the step (e02) is not satisfied.

In one embodiment, the printing material is a transparent printing material or support material.

In one embodiment, in the step (e01) and the step (e02), the output voltage is adjusted by manual adjustment through a variable resistor or by automatic adjustment through an electronic resistor.

In one embodiment, further includes steps of: (e11) adjusting an output voltage of the sensor to be greater than or equal to a fourth detection voltage under the condition without the printing material, (e12) adjusting the output voltage is between a fifth detection voltage and a sixth detection voltage under a condition of filling the printing material, wherein the fourth detection voltage is greater than the fifth detection voltage and the sixth detection voltage, (e13) using the sensor for detecting the liquid level of the printing material when the step (e11) and the step (e12) are both satisfied, and (e14) not being used for liquid level detection of the printing material when at least one of the step (e11) and the step (e12) is not satisfied.

In one embodiment, the printing material is a colored printing material or model material. In one embodiment, in the step (e11) and the step (e12), the output voltage is adjusted by manual adjustment through a variable resistor or by automatic adjustment through an electronic resistor.

In one embodiment, further includes a step of: providing a voltage follower circuit to avoid an output voltage of the sensor from being disturbed.

In one embodiment, further includes a step of: providing a Schmitt trigger coupled to the sensor to receive the output voltage of the sensor to reduce an error of the output voltage of the sensor caused by the printing material remaining on a tank wall of the printing material tank.

In one embodiment, further includes steps of: providing a variable resistor coupled to the sensor, and adjusting a variable resistance of the variable resistor and threshold voltages of the Schmitt trigger to reduce the error of the output voltage of the sensor caused by the printing material remaining on the tank wall of the printing material tank.

In one embodiment, the number of the sensors is three, including a low level sensor, a middle level sensor, and a high level sensor.

In one embodiment, the low level sensor detects that whether the liquid level of the printing material is insufficient so as to activate an injection of the printing material; the middle level sensor detects that whether the liquid level of the printing material is full so as to stop the injection of the printing material; the high level sensor detects that whether the liquid level of the printing material is higher than the liquid level of the printing material detected by the middle sensor so as to avoid damage to an air pressure system caused by the refilled printing material once the middle sensor fails.

In one embodiment, the printing material is a transparent printing material without particles or a white printing material with particles.

In one embodiment, the sensor is an infrared sensor.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawings as follows:

FIG. 1A is a schematic diagram of a liquid level detection of a transparent printing material according to the present disclosure.

FIG. 1B is a schematic diagram of a liquid level detection of a white printing material according to the present disclosure.

FIG. 2 is a flowchart of a method of detecting a liquid level of a printing material of a three-dimensional printer according to the present disclosure.

FIG. 3 is a flowchart of a method of selecting a single sensor according to the present disclosure.

FIG. 4 is a flowchart of a method of selecting a sensor for sensing a support material according to the present disclosure.

FIG. 5 is a flowchart of a method of selecting a sensor for sensing a model material according to the present disclosure.

FIG. 6 is a circuit diagram of a sensor, a voltage follower circuit, and a Schmitt trigger according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

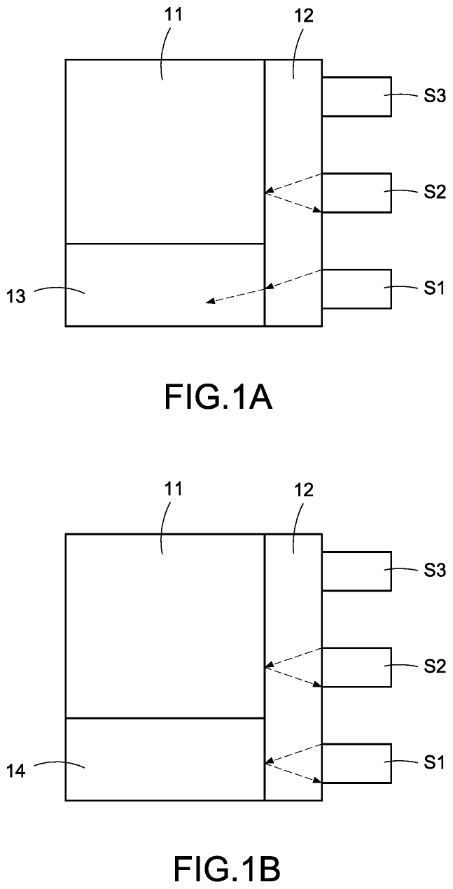

Please refer to FIG. 1A and FIG. 1B, which are schematic diagrams of a liquid level detection of a transparent printing material and a white printing material according to the present disclosure, respectively. Since the present disclosure mainly discusses material jetting technology, the remaining conditions of the printing materials (i.e., printing ink or printing liquid) in the printing material tank are determined by detecting the level of the printing materials in the printing material tank. Although in this specification, the description is made using “white” printed materials, it is not intended to limit the present disclosure. That is, in other embodiments, other colors may also be used, which is also referred to as colored printing materials. Generally, the transparent printing material is used as a support material, and the white printing material is used as a model material. However, this configuration is only one of the embodiments and is not intended to limit the present disclosure. In this specification, the white printing material compared to the transparent printing material is mainly to explain two different printing materials. White printing materials are based on the application of dyes for dyeing, which are larger or more than the particles usually contained in transparent printing materials. The main focus is still on the overall optical characteristics, such as reflectivity or refractive index or light transmittance (light transmittance), not limited to the absolute size or number of particles, nor is it limited to whether it contains human visually recognizable particles or not. In particular, the light transmittance of the transparent printing material is higher than that of the white printing material.

As shown in FIG. 1A, a printing material tank 11, a glass plate 12, a transparent printing material 13 installed in the printing material tank 11, and a plurality of sensors S1-S3 involving a first sensor S1, a second sensor S2, and a third sensor S3. In this embodiment, each of the sensors S1-S3 is an infrared sensor.

The sensors S1-S3 are respectively disposed at different heights of the printing material tank 11. For example, the first sensor S1 (also referred to as a “down sensor”) is disposed at a low liquid level of the printing material tank 11, the second sensor S2 (also referred to as an “up sensor”) is disposed at a medium liquid level of the printing material tank 11, and the third sensor S3 (also referred to as a “safety sensor”) is disposed at a high liquid level of the printing material tank 11. When the transparent printing material 13 in the printing material tank 11 is higher than the high liquid level and the third sensor S3 does not detect that, the transparent printing material 13 is refilled into the air pressure system (not shown) to make the air pressure system be damaged since the transparent printing material 13 is continuously injected. When the transparent printing material 13 in the printing material tank 11 is lower than the low liquid level and the first sensor does not detect that, the printing process fails since the transparent printing material 13 is not provided in the empty tank under the condition that no ink be supplied during the continuous printing process.

Specifically, the first sensor S1 (also referred to as a “low level sensor”) detects that the liquid level of the printing material is insufficient to activate the injection of the printing material. The second sensor S2 (also referred to as a “middle level sensor”) detects that the liquid level of the printing material is full to stop the injection of the printing material. The third sensor S3 (also referred to as a “high level sensor”) detects that the liquid level of the printing material is higher than the liquid level of the printing material detected by the second sensor to avoid damage to the air pressure system caused by the refilled printing material once the second sensor S2 fails.

Further, the liquid level detection and operation shown in FIG. 1A will be described. Take the operation of the first sensor S1 and the second sensor S2 as an example. As shown in FIG. 1A, when the liquid level is higher than the first sensor S1 and lower than the second sensor S2 and the second sensor S2 does not detect the transparent printing material 13, the second sensor S2 (i.e., an infrared sensor) reflects most of the infrared rays through the glass plate 12. Since the second sensor S2 receives most of the reflected infrared rays, a voltage outputted by the second sensor S2 is a high level, such as but not limited to a voltage greater than 2.8 volts. When the first sensor S1 detects the transparent printing material 13, the first sensor S1 scatters most of the infrared rays through the glass plate 12 into the printing material tank 11, that is, less infrared light is reflected back to the first sensor S1, and therefore a voltage outputted by the first sensor S1 is a low level, such as but not limited to a voltage less than 1.0 volt. Accordingly, according to the voltage levels outputted by the sensors S1-S3, the status of the liquid level of the transparent printing material 13 can be determined as a basis for adding the printing ink or stopping adding the printing ink.

Further, the liquid level detection and operation shown in FIG. 1B will be described. Take the operation of the first sensor S1 and the second sensor S2 as an example. For the white printing material 14 with particles (compared to the transparent printing material 13 without particles), see FIG. 1B for the description. As shown in FIG. 1B, when the liquid level is higher than the first sensor S1 and lower than the second sensor S2 and the second sensor S2 does not detect the white printing material 14, the second sensor S2 (i.e., the infrared sensor) reflects most of the infrared rays through the glass plate 12. Since the second sensor S2 receives most of the reflected infrared rays, a voltage outputted by the second sensor S2 is a high level, such as but not limited to a voltage greater than 2.8 volts. When the first sensor S1 detects the white printing material 14, the first sensor S1 also reflects most of the infrared rays through the glass plate 12, and therefore a voltage outputted by the first sensor S1 is also a high level. In other words, for the white printing material 14 with particles, whether the white printing material 14 is detected or not, the sensor also outputs an output voltage with high level. Therefore, the present disclosure provides correction and compensation for the liquid level height of the white printing material 14 in order to reach a correct determination of the liquid level height of the white printing material 14 in the printing material tank 11. Accordingly, the liquid level detection of the present disclosure can be applied to both the transparent printing material 13 and the white printing material 14.

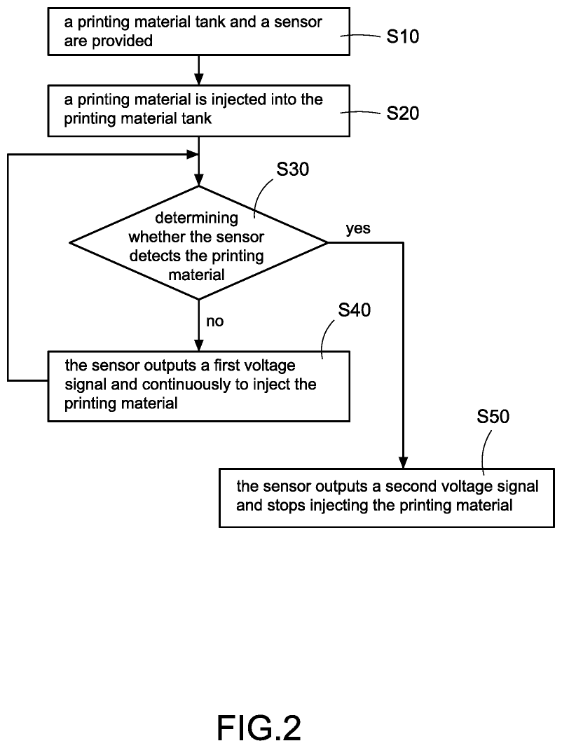

Please refer to FIG. 2, which shows a flowchart of a method of detecting a liquid level of a printing material of a three-dimensional printer according to the present disclosure. The method includes steps as follows. First, a printing material tank and a sensor are provided (S10). In this embodiment, one sensor is taken as an example. However, the number of sensors can be increased according to actual needs, such as the aforementioned three sensors. It is assumed that the current printing material tank is empty. Afterward, a printing material is injected into the printing material tank (S20). Afterward, a liquid level determination circuit (as detailed later) coupled to the sensor determines whether the sensor detects the printing material by detecting a voltage signal outputted from the sensor (S30). When the sensor does not detect the printing material, the sensor outputs a first voltage signal, and the liquid level determination circuit determines that the printing material has not been detected, and continuously injects the printing material (S40). Since the sensor does not detect the printing material, the first voltage signal is a high level (for example but not limited to 2.8 volts). At this condition, it means that the printing material has not reached the liquid level target, and therefore the printing material is continuously injected. Once the sensor detects the printing material, the sensor outputs a second voltage signal, and the liquid level determination circuit determines that the printing material has been detected, and stops injecting the printing material (S50). Since the sensor detects the printing material, the level of the second voltage signal is a low level (for example but not limited to 1.0 volt). At this condition, it means that the printing material has reached the liquid level target, and therefore, the printing material is stopped from being injected. Accordingly, the liquid level detection operation of the printing material of the 3D printer is completed, and the liquid level detection of both the transparent printing material and the white printing material is applicable. The details are as follows.

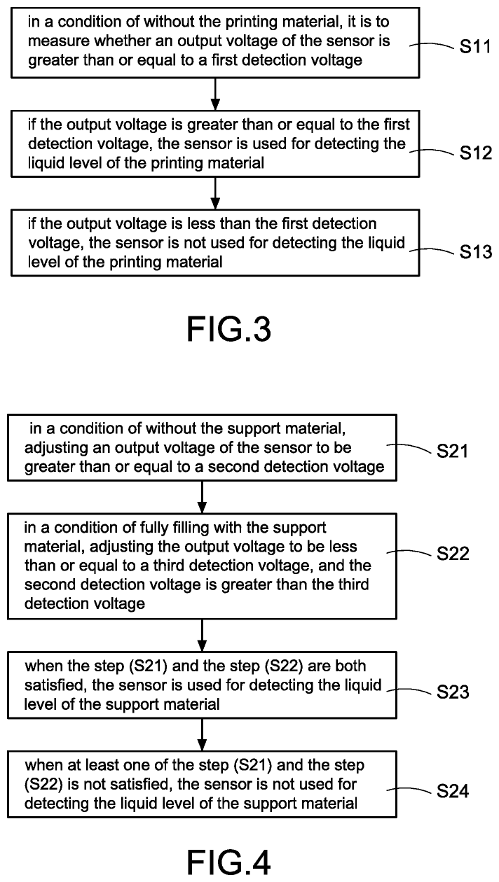

Please refer to FIG. 3, which shows a flowchart of a method of selecting a single sensor according to the present disclosure. In order to confirm the sensing capability of the sensor, the sensors to be used are selected before using the sensors, and therefore sensors with a better sensing capability are selected for the liquid level detection of the present disclosure. First, in a condition of without the printing material, it is to measure whether an output voltage of the sensor is greater than or equal to a first detection voltage (S11). In particular, the first detection voltage is, for example but not limited to, 2.8 volts. If the output voltage is greater than or equal to the first detection voltage, the sensor is used for detecting the liquid level of printing materials (S12). On the contrary, if the output voltage is less than the first detection voltage, the sensor is not used for detecting the liquid level of printing materials (S13). Therefore, through the above steps (that is, steps (S11) to (S13)), the sensors with a better sensing capability can be initially selected for use as the liquid level detection of the present disclosure.

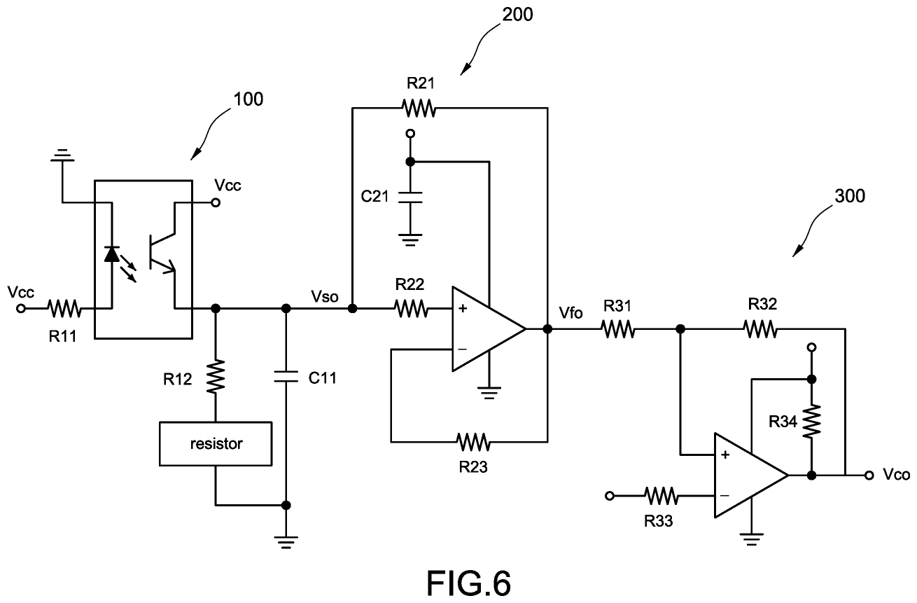

Please refer to FIG. 6, which shows a circuit diagram of a sensor, a voltage follower circuit, and a Schmitt trigger according to the present disclosure. After acquiring multiple usable single sensors, place the usable sensors on a circuit board, and functional circuits, such as a voltage follower circuits and a Schmitt trigger are used to achieve specific purposes, described in detail below. For example, if three sensors (i.e., a down sensor, an up sensor, and a safety sensor) are required for each of the support material tank and the model material tank, six sensors are required. Further, each of the sensors corresponds to a variable resistor. As shown in FIG. 6, an output of the sensor 100 is coupled to the voltage follower circuit 200, and an output of the voltage follower circuit 200 is coupled to the Schmitt trigger 300. The voltage follower circuit 200 is used to avoid analog signals outputted from the sensor 100 from being disturbed. Cooperate with the Schmitt trigger 300 to compensate the error of the sensing result of the sensor 100 caused by the print material remaining in the tank. In the present disclosure, since the viscosity of the printing material used is 50 cp and it is relatively thick, it can easily remain in the tank, causing partial scattering of infrared rays emitted by the sensor 100. As a result, the output voltage of the sensor 100 is reduced, and thus a situation where a small amount of printing material remains on the tank wall is mistakenly determined as that the tank is still full of sufficient printing material. Therefore, in order to reduce the influence of the residue of the printing material to the output voltage, an upper threshold voltage (or a positive threshold voltage) Va and a lower threshold voltage (or a negative threshold voltage) Vb are designed. The upper threshold voltage Va may be, but not limited to, 2.075 volts, and the lower threshold voltage Vb may be, but not limited to, 1.826 volts. Therefore, when the output voltage is greater than the upper threshold voltage Va, it is regarded as a state of outputting a high level, and when the output voltage is less than the lower threshold voltage Vb, it is regarded as a state of outputting a low level. Finally, a digital signal outputted by the Schmitt trigger 300 is passed through a buffer integrated circuit (IC) with an anti-noise function to acquire a digital signal that can be determined by the system.

In order to avoid the misjudgment of the printing material remaining on the tank wall, the adjustment of the variable resistor should be based on the principle of increasing the output voltage as much as possible. However, the output voltage of the variable resistor cannot be adjusted blindly and without limit. Since it is used to detect both support material and model material (or two different printing materials) and the white printing material may be detected, the voltage of the sensor may rise to the threshold voltage of the Schmitt trigger to influence determination. For example, when a white printing material is detected, the white printing material in the tank is not actually lower than the predetermined liquid level, but it is misjudged that it is lower than the predetermined liquid level due to the voltage value setting. Therefore, although the adjustment of the variable resistor should be based on the principle of increasing the output voltage as much as possible to avoid the misjudgment mentioned above, it should still be adjusted within a certain range in accordance with the threshold voltage of the Schmitt trigger. In one embodiment, the output voltage of the variable resistor is adjusted between approximately 1.50 volts and 1.55 volts.

For the sensors arranged on the circuit board, the sensors can be further selected to meet the actual detection requirements of the system as a whole. The sensors for detecting the support material may be first selected, and then the sensors for detecting the model material may be selected, described as follows.

The support material tank requires three sensors, and a variable resistor corresponding to each of the sensors can be used to adjust the output voltage. Please refer to FIG. 4, which shows a flowchart of a method of selecting a sensor for sensing a support material according to the present disclosure. First, in a condition of without the support material, adjusting an output voltage of the sensor to be greater than or equal to a second detection voltage (S21). The second detection voltage is, for example but not limited to, 2.9 volts. In the step (S21), in the condition of an empty tank (i.e., the absence of the support material), if the output voltage of the sensor cannot be greater than or equal to the second detection voltage, the sensor is eliminated and is not used for liquid level detection. Afterward, in a condition of fully filling with the support material, adjusting the output voltage to be less than or equal to a third detection voltage, and the second detection voltage is greater than the third detection voltage (S22). The third detection voltage is, for example but not limited to, 1.0 volt.

Therefore, when the step (S21) and the step (S22) are both satisfied, the sensor is used for detecting the liquid level of the support material (S23). Furthermore, when at least one of the step (S21) and the step (S22) is not satisfied, the sensor is not used for detecting the liquid level of the support material (S24). In the step (S22), if the output voltage is not less than or equal to the third detection voltage when the support material is filled, the variable resistor corresponding to the sensor can be adjusted so that the output voltage is less than or equal to the third detection voltage, and the step (S21) is performed again. That is, under the condition of an empty tank, it is measured whether the output voltage of the sensor is still greater than or equal to the second detection voltage. If “YES”, the sensor can be used for detecting the liquid level of the support material, and can be regarded as meeting the requirements of the step (S23). If “NO”, the sensor is not used for detecting the liquid level of the support material. As mentioned above, by manually adjusting the variable resistor as a way to adjust the output voltage, an electronic resistor can be used instead of the variable resistor. By adjusting the electronic resistor in the form of firmware, it enters a fully automatic adjustment manner to increase the accuracy and convenience of adjustment.

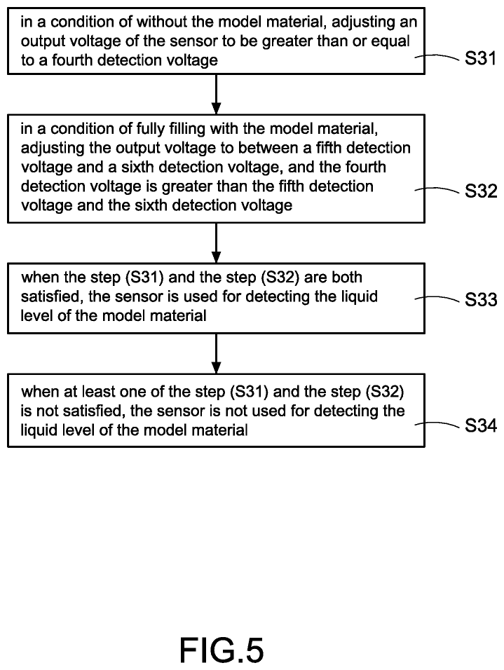

The support material tank requires three sensors, and a variable resistor corresponding to each of the sensors can be used to adjust the output voltage. Please refer to FIG. 5, which shows a flowchart of a method of selecting a sensor for sensing a model material according to the present disclosure. First, in a condition of without the model material, adjusting an output voltage of the sensor to be greater than or equal to a fourth detection voltage (S31). The fourth detection voltage is, for example but not limited to, 2.6 volts. In the step (S31), in the condition of an empty tank (i.e., the absence of the model material), if the output voltage of the sensor cannot be greater than or equal to the fourth detection voltage, the sensor is eliminated and is not used for liquid level detection. Afterward, in a condition of fully filling with the model material, adjusting the output voltage to between a fifth detection voltage and a sixth detection voltage, and the fourth detection voltage is greater than the fifth detection voltage and the sixth detection voltage (S32). The fifth detection voltage is, for example but not limited to, 1.50 volts, and the sixth detection voltage is, for example but not limited to, 1.55 volts.

Therefore, when the step (S31) and the step (S32) are both satisfied, the sensor is used for detecting the liquid level of the model material (S33). Furthermore, when at least one of the step (S31) and the step (S32) is not satisfied, the sensor is not used for detecting the liquid level of the model material (S34). In the step (S32), if the output voltage is not between the fifth detection voltage and the sixth detection voltage when the model material is filled, the variable resistor corresponding to the sensor can be adjusted so that the output voltage is between the fifth detection voltage and the sixth detection voltage, and the step (S31) is performed again. That is, under the condition of an empty tank, it is measured whether the output voltage of the sensor is still greater than or equal to the fourth detection voltage. If “YES”, the sensor can be used for detecting the liquid level of the model material, and can be regarded as meeting the requirements of the step (S33). If “NO”, the sensor is not used for detecting the liquid level of the model material. As mentioned above, by manually adjusting the variable resistor as a way to adjust the output voltage, an electronic resistor can be used instead of the variable resistor. By adjusting the electronic resistor in the form of firmware, it enters a fully automatic adjustment manner to increase the accuracy and convenience of adjustment.

In conclusion, the present disclosure has following features and advantages:

1. The simple infrared sensor for liquid level detection can reduce costs and simplify circuits.

2. By selecting the sensors, the sensors with better sensing capability can be used for liquid level detection.

3. By correcting the output voltage of the sensor, the sensors suitable for both the transparent printing material and the white printing material can be acquired for liquid level detection.

4. By adjusting the output voltage of the sensor, the situation that a small amount of printing material remains on the tank wall can be prevented from being misjudged as the tank is still full of sufficient printing material.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of detecting a liquid level of a printing material of a three-dimensional printer, comprising steps of:
(a) providing a printing material tank and a sensor,
(b) injecting a printing material into the printing material tank,
(c) outputting, by the sensor, a first voltage signal and continuously injecting the printing material when the sensor does not detect the printing material, and
(d) outputting, by the sensor, a second voltage signal and stopping injecting the printing material when the sensor detects the printing material, wherein a voltage level of the first voltage signal is greater than a voltage level of the second voltage signal.

2. The method of detecting the liquid level of the printing material of the three-dimensional printer in claim 1, wherein before the step (a) further comprises steps of:
(a1) detecting whether an output voltage of the sensor is greater than or equal to a first detection voltage under a condition without the printing material,
(a2) using the sensor for detecting the liquid level of the printing material when the output voltage is greater than or equal to the first detection voltage, and
(a3) not being used for liquid level detection of the printing material when the output voltage is less than the first detection voltage.

3. The method of detecting the liquid level of the printing material of the three-dimensional printer in claim 1, further comprising steps of:
(e01) adjusting an output voltage of the sensor to be greater than or equal to a second detection voltage under the condition without the printing material,
(e02) adjusting the output voltage is less than or equal to a third detection voltage under a condition of filling the printing material, wherein the second detection voltage is greater than the third detection voltage,
(e03) using the sensor for detecting the liquid level of the printing material when the step (e01) and the step (e02) are both satisfied, and
(e04) not being used for liquid level detection of the printing material when at least one of the step (e01) and the step (e02) is not satisfied.

4. The method of detecting the liquid level of the printing material of the three-dimensional printer in claim 3, wherein the printing material is a transparent printing material or support material.

5. The method of detecting the liquid level of the printing material of the three-dimensional printer in claim 3, wherein in the step (e01) and the step (e02), the output voltage is adjusted by manual adjustment through a variable resistor or by automatic adjustment through an electronic resistor.

6. The method of detecting the liquid level of the printing material of the three-dimensional printer in claim 1, further comprising steps of:
(e11) adjusting an output voltage of the sensor to be greater than or equal to a fourth detection voltage under the condition without the printing material,
(e12) adjusting the output voltage is between a fifth detection voltage and a sixth detection voltage under a condition of filling the printing material, wherein the fourth detection voltage is greater than the fifth detection voltage and the sixth detection voltage,
(e13) using the sensor for detecting the liquid level of the printing material when the step (e11) and the step (e12) are both satisfied, and
(e14) not being used for liquid level detection of the printing material when at least one of the step (e11) and the step (e12) is not satisfied.

7. The method of detecting the liquid level of the printing material of the three-dimensional printer in claim 6, wherein the printing material is a colored printing material or model material.

8. The method of detecting the liquid level of the printing material of the three-dimensional printer in claim 6, wherein in the step (e11) and the step (e12), the output voltage is adjusted by manual adjustment through a variable resistor or by automatic adjustment through an electronic resistor.

9. The method of detecting the liquid level of the printing material of the three-dimensional printer in claim 1, further comprising a step of:
providing a voltage follower circuit to avoid an output voltage of the sensor from being disturbed.

10. The method of detecting the liquid level of the printing material of the three-dimensional printer in claim 1, further comprising a step of:
providing a Schmitt trigger coupled to the sensor to receive the output voltage of the sensor to reduce an error of the output voltage of the sensor caused by the printing material remaining on a tank wall of the printing material tank.

11. The method of detecting the liquid level of the printing material of the three-dimensional printer in claim 10, further comprising steps of:
providing a variable resistor coupled to the sensor, and
adjusting a variable resistance of the variable resistor and threshold voltages of the Schmitt trigger to reduce the error of the output voltage of the sensor caused by the printing material remaining on the tank wall of the printing material tank.

12. The method of detecting the liquid level of the printing material of the three-dimensional printer in claim 1, wherein the number of the sensors is three, comprising a low level sensor, a middle level sensor, and a high level sensor.

13. The method of detecting the liquid level of the printing material of the three-dimensional printer in claim 12, wherein the low level sensor is configured to detect that whether the liquid level of the printing material is insufficient so as to activate an injection of the printing material; the middle level sensor is configured to detect that whether the liquid level of the printing material is full so as to stop the injection of the printing material; the high level sensor is configured to detect that whether the liquid level of the printing material is higher than the liquid level of the printing material detected by the middle sensor so as to avoid damage to an air pressure system caused by the refilled printing material once the middle sensor fails.

14. The method of detecting the liquid level of the printing material of the three-dimensional printer in claim 1, wherein the printing material is a transparent printing material without particles or a white printing material with particles.

15. The method of detecting the liquid level of the printing material of the three-dimensional printer in claim 1, wherein the sensor is an infrared sensor.
